(19) United States
(12) Patent Application Publication
(10) Pub. No.: US 2005/0174950 A1
(43) Pub. Date: Aug. 11, 2005

(54) Distributed network organization and topology discovery in ad-hoc network

(75) Inventor: Deepak V. Ayyagari, Vancouver, WA (US)

Correspondence Address: Robert D. Varitz;ROBERT D. VARITZ, P.C., 2007 S.E. Grant Street, Portland, OR, 97214, US

(73) Assignee: Sharp Laboratories of America, Inc.

(21) Appl. No.: 10/775,967

(22) Filed: Feb. 9, 2004

(51) Int. Cl. H04L 12/28

(52) U.S. Cl. 370/254

(57) ABSTRACT

A distributed network method for self-organizing a group of nodes into a bi-directional communication network where initially there is no central coordinator in the prospective network environment. The method involves engaging in the process of determining internodal communication capabilities en route to creating a network topology table, and then using that table as a guide (a) selecting, by nodal election, an appropriate central coordinator, and (b) establishing proxy nodes which enable full network bi-directional communication between all nodes, including otherwise communicatively-compromised hidden nodes.

### BACKGROUND AND SUMMARY OF THE INVENTION

This invention pertains to distributed communication-network organization, and more particularly to a process for self-organization into a network by a collection of nodes, also referred to as devices. The invention, its features, and its algorithms arise from a premise and an assumption that initial organization will take place in the absence of the presence of any central coordinator node, a so-called CCo. The specific medium which interconnects nodes in the resulting network is referred to herein both as a medium, and as a channel.

In the description herein of the present invention, the term “topology” is used. Topology relates to knowledge regarding (a) the identities of all nodes in a network, (b) the states of connectivity between nodes, (c) the identity of the eventually selected CCo, (d) the identities of so-called hidden nodes (defined below), and (e) the identity of what is referred to herein (later explained) as a proxy node.

In a self-organizing ad-hoc communication network, nodes need to learn about the presence of other nodes in the network and the availability of acceptable bi-directional links between any two nodes (topology discovery process). The nodes must be able to organize themselves into networks controlled ultimately by a suitable selected Central Coordinator Node (CCo). Ultimately, in the completely organized network, every node knows the state of links existing between all nodes in the network. The topology discovery process of this invention is employed any time a node joins or leaves the network, during recovery from network or node failure, when the network is initialized, or when any event that changes the topology of the network occurs. The process of network organization in this setting requires an algorithmic protocol for the exchange of relevant information between devices and the decision making processes required to organize the network.

The algorithms presented in this disclosure assume that the subject network will have the following attributes:

1. There is no CCo in the network before one is selected (elected) by the collective of nodes. Accordingly, each node maintains its own topology information data structure.

2. Nodes use a suitable random access protocol, such as ALOHA, to communicate with one another. There is no scheduling of access since there is initially no CCo.

3. There is no global timing reference or time frame structure used by all the nodes in the collective.

4. Once the network has been organized, a CCo exists in the network and controls access to the channel and entry of new devices to the network.

Included among unique aspects of the present invention are:

(a) A distributed method that allows new nodes to join the network when there is no CCo, as well as when the nodes cannot communicate with the ultimately elected CCo directly, but can communicate with other nodes. Thus the methodology of the present invention is unique because it allows for new nodes to join the network even when they cannot hear or communicate with the CCo if such a controller already exists. The methodology also allows new nodes the ability to be discovered by other nodes in the network even if they cannot directly communicate with the CCo. Such nodes are termed “hidden nodes” (HNs).

(b) A Distributed DISCOVERY process where nodes build local discovered node lists, indicating their own connectivity, followed by an exchange of these lists which allows nodes to build local states of the global connectivity information in the form of a Topology Table. This DISCOVERY protocol is unique in many ways. for example, usually nodes in ad-hoc networks do not maintain global network connectivity information. The present invention enables the generation and collection of connectivity information network-wide efficiently. Every device learns of its connectivity with all other nodes in one step. Devices then exchange local information with each other, and each device constructs its own picture of the global connectivity map. Devices do not have to “probe” individual links on an ad-hoc basis. Further, the methodology of the present invention enables the identification of HNs, and allows HNs to communicate with other devices as a part of the discovery process, i.e., HNs can be discovered through this process.

5. A distributed election algorithm that allows candidate devices to compete and finally concur on the appointment of a CCo.

In networks such as Bluetooth all nodes do not participate simultaneously in the organization of the network and selection of an optimal master, or CCo. They also do not so participate in the identification of hidden nodes and what are referred to herein as proxy nodes, or proxy coordinator (PCos). The election of a CCo takes place after individual nodes have analyzed their own snapshots of the global connectivity picture.

6. A method that identifies the optimal CCo device, a method that identifies the optimal collection of nodes to constitute the network, a method that identifies HNs, and a method to identify optimal PCos (one or more) to connect HNs to the CCo and the network.

This invention further contemplates a series of analyses that each device can perform on a created TOPOLOGY TABLE which is generated at the end of a DISCOVERY process to accomplish all the above listed functions. There is, I believe, no precedent in literature that allows every device independently to assimilate global connectivity and device capability data, and to analyze it for optimal selection of the device to fulfill the role of CCo, and perform all the other functions, in this manner. This method is extremely efficient, inasmuch as (a) it results in the optimal network configuration (best CCo device, best PCos, best network and hidden node configurations), and (b) the optimal configuration is determined with distributed decision making in the absence of a central repository of information, or a central control entity.

Further describing the setting for the present invention, topology discovery is the process by which individual nodes in a network (e.g., hosts, bridges, routers etc.) learn the configuration of the network and the connectivity between any two individual nodes. This is important for network management, for efficient routing, and for resource management. In the case of ad-hoc networks, the processes of discovery and network organization (how nodes organize themselves into clusters or sub-nets with designated subnet managers or controllers) are fundamental to the efficient operation of such networks.

The present invention addresses topology discovery and network organization matters, as well as other issues in an ad-hoc network which possesses the following characteristics:

1. The nodes share a common transmission medium which may be wired (power line networks) or wireless. This requires an appropriate multiple access protocol, as in the case of Ethernet. Further, the nodes are not required to possess any “carrier sense” capability.

2. Connectivity between any two nodes is a function of the capabilities of the node and channel characteristics. Under the best transmission conditions for digital communications (power, modulation density, symbol duration, coding etc), all nodes do not necessarily hear all other nodes. Further, links between devices are not symmetric i.e., one node A may hear (receive and correctly decode packets) from another node B while B may not hear A.

3. The network in its operational mode consists of host nodes, a designated controller for the network, called the CCo, and possibly a set of PCos to communicate with nodes that cannot directly communicate (in a single link) with the CCo, or with other nodes in the network. A subnet is a collection of nodes that can all hear each other. “Hidden” nodes are nodes that are not a part of the subnet, and that may or may not be able to communicate with the CCo and a PCo node that belongs to the subnet.

4. The network is self-organizing in that the nodes have to establish the configuration of the network, and choose a central coordinator. This decision making may be accomplished in a distributed fashion by each node making an independent decision, or by a central repository of relevant information. Network organization is required when certain events cause a significant change in network topology, such as during initialization, recovery from failures of hosts, PCos, CCos, when channel conditions between nodes change significantly causing outages, and when new nodes join or leave the network.

5. Once the network has been organized, an elected CCo controls the activity of the nodes in the sub-network through a time division access protocol. The existence of a CCo in the network implies:
(a) That a timing reference is available, which allows nodes in the subnet to synchronize to a universal time frame during which access is scheduled.

(b) Access to the medium/channel is scheduled by the CCo. Nodes are allowed to transmit only upon receiving explicit authorization from the CCo or a PCo.

The CCo may also schedule time within a time frame for random access of the channel, during which all nodes are free to transmit as per the random access protocol agreed to by all nodes.

6. Nodes can directly communicate with one another, during periods scheduled by the CCo, and do not have to use the CCo as an interim node or relay.

An example topology 20 with five nodes, designated A (22), B (24), C (26), D (28), E (30), respectively, is shown in FIG. 1. More will be said shortly about these illustrative nodes.

In a self-organizing distributed network with characteristics such as those outlined above, nodes need to learn about the presence of other nodes in the network as well as about the availability of acceptable bi-directional links between any two nodes. The nodes must also organize themselves into networks controlled by a suitable selected (elected in accordance with practice of the present invention) CCo. This is required, for example, any time that a node joins or leaves the network, during recovery from network or node failure, and when the network is initialized. The process of network organization requires the following:

1. A medium access protocol to allow the nodes to communicate with one another in the absence of scheduled access via a CCo controlled access scheme.

2. A protocol for the exchange of relevant information between devices and the decision making required to organize the network.

### Medium Access Control in the Absence of a CCo

The absence of a CCo implies that there is no network wide timing reference, and that access to the medium is no longer controlled or scheduled. Further, if one assumes that nodes lack “carrier sense” capability, as in CSMA-CA Ethernet, a pure ALOHA access scheme might be used (not slotted ALOHA because transmissions are not of fixed lengths (time durations or slots) and nodes are not time synchronized to slot boundaries). A random back-off algorithm might be used to reduce collisions and improve throughput.

However, such a protocol does not ensure that all nodes that need to be discovered get a chance to speak up and be heard by the other nodes in the network. Given the maximum throughput limits of ALOHA, being <1/e (for large populations of nodes and Poisson arrivals), the delay incurred in getting a reasonable number of nodes to discover one another could be large. These factors make the ALOHA protocol not particularly efficient for topology discovery and network organization. A medium access control protocol with enhanced collision avoidance mechanisms is required to improve throughput and reduce the time for discovery and organization.

### Topology Discovery and Network Organization

In addition to nodes in a distributed network learning about each other's presences, capabilities and qualities of communications links between them (topology discovery), the nodes must perform the following important functions as a part of network organization before applications can exchange information between the nodes:

1. The identification of the network (all nodes in a network can communicate directly with each other).

2. Selection of a CCo from a set of nodes that can fulfill that role, to control each subnet.

3. The identification of HNs.

4. The identification of PCos that can communicate and control the hidden nodes in conjunction with the CCo.

More detailed descriptions of these functions are provided later herein. An algorithm and protocol is required to accomplish the above functions. The CCo, once designated, can enforce an appropriate access scheme, such as a TDM access scheme, and can facilitate point-to-point or point-to-multipoint communications between nodes.

With reference again to FIG. 1, six double-ended arrows 32, 34, 36, 38, 40, 42 represent operative connections between the five nodes illustrated in this figure. Arrow 32 extends between nodes 22, 24, arrow 34 between nodes 22, 26, arrow 36 between nodes 24, 26, arrow 38 between nodes 26, 28, arrow 40 between nodes 26, 30, and arrow 42 between nodes 28, 30.

Within this arrangement at least two network configurations are possible, and these are shown at 44 (Net 1) and 46 (Net2). Net 1 includes node A (22) as the CCo, B (24) and C (26) as hosts within the network, and C (26) as a PCo for the hidden nodes D (28) and E (30). Net 2 includes node C (26) as the CCo, D (28) and E (30) as the hosts within the network, and C (26) as a PCo for the hidden nodes A (22) and B (24). A network with only A, B and C as host nodes, and A as the CCo would leave nodes D and E unconnected. The network performance will be significantly different in the two configurations based on the traffic load handled by nodes chosen as CCos, by the overhead of having a node function additionally as a PCo (separate from a CCo), and if the quality (capacity) of links between the CCo and the nodes varies, among several other factors. In Net 2, C (26) can act both as the CCo and the PCo, and can directly communicate with all four nodes. In Net 1, A (22) as the CCo can only communicate directly with two other nodes (B and C), and needs a proxy (also referred to as a surrogate) to handle nodes D and E. Thus, one can see that the characters of a network organization algorithm and a protocol are critical to the providing of connectivity (networking) of all the nodes in the system, and for efficient, low-overhead performance of the resulting network.

As was mentioned herein earlier, the present invention features a distributed algorithmic approach (DNOA), which, for organizational purposes, does not require either a central repository for information, or a central-decision making entity.

In accordance with a preferred and best-mode manner of practicing the invention, nodes wishing to enter a distributed network engage initially in a listening mode wherein they do not transmit, but rather listen to detect the transmission of a beacon created by any pre-established CCo (or in accordance with practice of this invention, a PCo). They do not transmit during this listening period.

When no beacon is detected, and such will be the case initially before any distributed network has been organized, they follow the listening period into a discovery period, wherein they cross-communicate to determine the presences and identities of all nodes with which they are respectively able to communicate bi-directionally, and from this discovery activity, each node creates its own discovered-node list.

At the end of the discovery process, (a) the nodes engage in an election process wherein they all transmit and exchange their respective identities and discovered-node lists, (b) the nodes create a comprehensive topology table, and (c), employing certain rules, they effectively elect certain nodes to hold the statuses of CCo and PCo.

Following this election process, the nodes then analyze their topology tables to learn about the resulting organization of the network, and thereby become informed by the elected node(s) about the identities of hidden nodes and PCOs.

Thus the network self-organizes and shapes itself potentially into several different categories of nodes, including non-hidden nodes, hidden nodes, one or more CCo node(s), and one or more proxy PCo node(s). All nodes in the formed network are thus ultimately capable of communicating bi-directionally with all other nodes, either directly (in a single link), or indirectly through plural links that are “managed” through one or more proxy node(s).

Thereafter, under the control of the elected CCo, beacon transmission, and normal network operation commence.

The various special features and advantages offered by the present invention will become more fully apparent as the detailed description which now follows is read in conjunction with the accompanying drawings.

### DESCRIPTION OF THE DRAWINGS

FIG. 1, which has already been discussed above in the introductory material in this disclosure, illustrates, in block/schematic form, a network environment suitable for practice of the present invention.

FIG. 2 presents a diagram which pictures the basic stages of activity involved in practice of the invention.

FIG. 3 is a block/schematic diagram which further details the content of FIG. 2.

FIG. 4 shows the format of a NODE_DISCOVER_MSG message employed in the practice of the invention.

FIG. 5 shows the format of a CCo_ELECT_MSG message.

FIG. 6 pictures an abbreviated form, CCo_ELECT_MSG_SHORT, of a CCo_ELECT_MSG message.

FIG. 7 presents the format of a CCo_CONFIRM_MSG message.

FIG. 8 illustrates the format of a CCo_CONFIRM_MSG_SHORT message.

FIG. 9 is a block/schematic algorithmic illustration of a listening mode which is implemented during practice of the invention.

FIG. 10 pictures an organized network topology table that has resulted from practice of the invention. This table is related to the network arrangement shown in FIG. 1.

FIG. 11 provides a table illustrating a representative order of preferences involved during practice of the present invention to select a CCo.

### DETAILED DESCRIPTION OF THE INVENTION

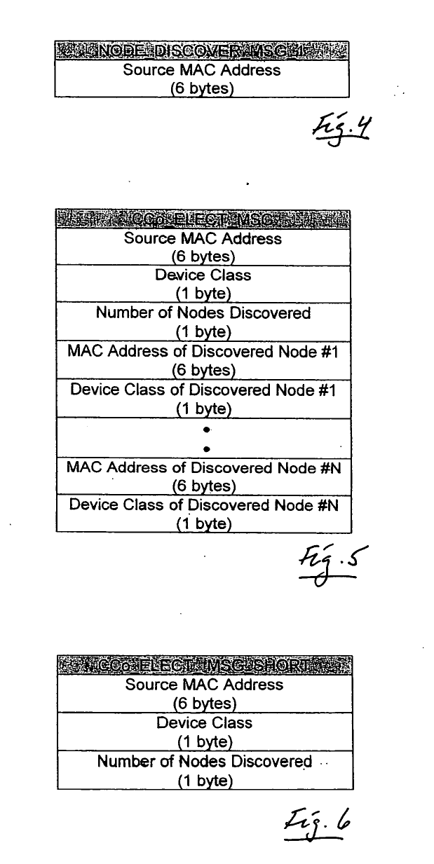

Turning now to the drawings, and referring first of all to related FIGS. 2 and 3, in FIG. 2 there is illustrated, in the form generally of a linear bar graph 47, the basic order of steps performed by practice of the present invention. These steps, in abbreviated terminology, include Listen 47a, Discover 47b, Nominate/Elect 47c, and Confirm 47d, all of which lead ultimately to Operate 47e.

Every node that seeks to join the network for the first time, or to return to the network it was previously affiliated with after a failure or outage event, uses the process of this invention. As shown in FIG. 2, this process defines five states that a node engages sequentially. The Finite State Machine for this process, which essentially details what is pictured more generally in FIG. 2, is shown in FIG. 3. This process uses a set of timers and messages that nodes transmit in each state. Transitions between states are either message-event-driven or timer-driven. Message-driven events are those that result when a node takes action upon receiving one of the messages that will be discussed later in this text. Timer expiry events also lead to state transitions.

Set forth now in five separate and immediately following paragraphs is a brief “operational tour” through FIGS. 2 and 3.

1. Listen: The node starts a timer set for a duration, and begins monitoring the shared common communication channel. In this state the node is forbidden from transmitting. The node can receive different messages during this interval that determine the subsequent state. During this state the node uses a timer called T_LISTEN.

2. Discover: During the discovery phase the node uses any appropriate random access protocol to transmit messages called NODE_DISCOVER_MSG that advertise the MAC address (or identity) of the node, and that indicate the presence of the node to all other nodes already in the network, or wishing to form a network. At the same time the node listens to all other transmissions on the shared common communication channel and begins preparing a list called DISCOVERED_NODES_LIST. During this state, the node uses a timer called T_DISCOVER.

3. Elect: Following the discovery phase the generation of the TOPOLOGY_TABLE has to be completed by nodes exchanging their DISCOVERED_NODE_LISTS. The node also determines if it is a suitable candidate to perform the function of Central Coordinator (CCo). The criteria for determining suitability to be a CCo candidate are defined later herein. The node once again uses an appropriate random access protocol to communicate with peer nodes that have participated in the discovery process by transmitting the CCo_ELECT_MSG. Based on rules of precedence, one node is elected to be the CCo at the end of this process. During this state, the node uses a timer called T_ELECT.

4. Confirm: After completion of the election process, nodes analyze their TOPOLOGY_TABLES to learn the organization of the network. The node elected as CCo transmits the CCo_CONFIRM_MSG message periodically for a period of time determined by the timer T_CONFIRM used by the node in this state. Through this message, the CCo node informs other nodes of its identity (MAC address), identities of “hidden nodes”, and the identities of any nodes it designates as Proxy Coordinators (PCos). All other nodes remain silent, and listen to the transmissions from the node elected as CCo.

5. Operate: At the end of the confirmation period the node designated as CCo begins transmission of a BEACON message at the beginning of each time frame, and the network begins operation in a TDM mode. Within a time frame, nodes transmit at times designated explicitly by the CCo node.

According to the present invention, the CCo can activate network organization using the process of this invention at any time by the transmission of a NODE_DISCOVER_MSG. All nodes enter the DISCOVER state when they receive this message from the CCo. The CCo must initiate the discovery and network organization periodically (every few frames). The T_LISTEN timer must be set to a value greater than the maximum time interval between such organization opportunities called by the CCo. A new node joining the network can participate in the discovery process once it hears a discover message from any node in the network. The CCo might also choose to activate the invention process at critical points, such as: a new node communicating with the CCo its intention to join the network through a broadcast channel made available by the CCo, by the CCo initiating recovery from network failure, etc.

Messages used in the different phases of practice of the invention are now discussed. Representative message formats are illustrated and described wherein it should be understood that the sizes of the different information fields, and suggested values therein, are not critical.

NODE_DISCOVER_MSG

This message is transmitted by every node to every other node in the network using any suitable random access protocol, such as ALOHA, during the DISCOVER process. FIG. 4 illustrates the architecture of this message. This message simply identifies the transmitting node by a unique identity such as the 6-byte MAC address used by networks such as Ethernet (IEEE Ethernet address).

CCo_ELECT_MSG

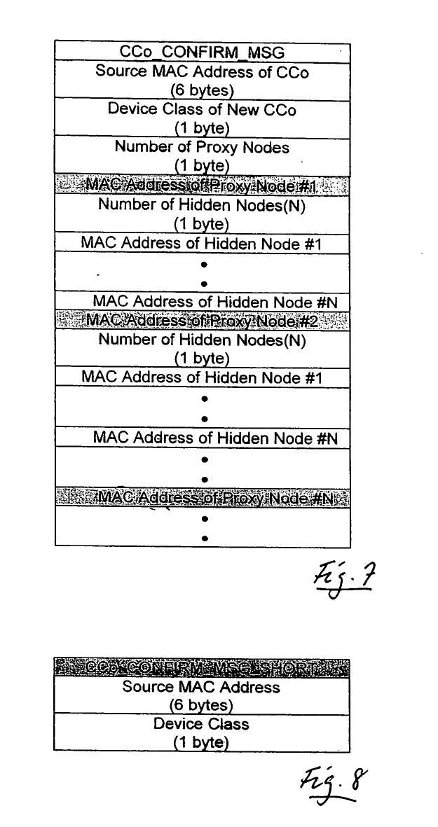

This message, the make-up of which is pictured in FIG. 5, is transmitted, by every node that has generated a DISCOVERED_NODE_LIST to every other node in the network. The message contains information that each node analyzes independently to determine if the node is a candidate node for the role of CCo. This message, using a random access protocol such ALOHA, is transmitted during the NOMINATE/ELECT processes which form part of the present invention.

The fields in this message are described as follows:

1. Source MAC Address: This is a 6-byte field which uniquely identifies the source of the message. This is typically the 6-byte IEEE assigned MAC address, as in the case of Ethernet.

2. Device Class Present Field: If the system implements nodes or devices with different sets of capabilities, and if these devices are classified and accorded precedence based on the class, then this field is used to specify the class of the transmitting node. Device class may be used as a determining factor in the choice of CCo. The system may define, as an illustration, up to 256-Device Classes.

3. Number of Nodes Discovered: This field indicates how many devices were heard by the node originating the CCo_ELECT_MSG message during the LISTEN and DISCOVER processes.

4. MAC Addresses: A list of unique identifiers for the nodes that have been heard/discovered by the node originating the message, usually the 6-byte IEEE MAC addresses.

5. Device Class of Discovered Nodes: This field indicates the type or class of the nodes discovered.

The list of MAC addresses and device class/type field of the discovered nodes together constitute a Discovered Nodes List.

CCo_ELECT_MSG_SHORT

This message, illustrated in FIG. 6, is an abbreviated form of the CCo_ELECT_MSG message.

CCo_CONFIRM_MSG

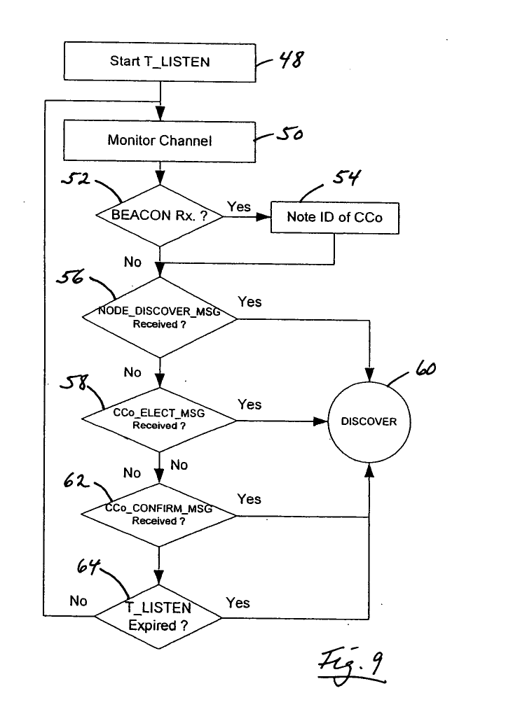

This message, whose architecture is presented in FIG. 7, is transmitted by every node that considers itself to be a candidate for the role of CCo after performance of the analysis which takes place in the NOMINATE/ELECT state.

The CCo_CONFIRM_MSG message confirms the identity of the CCo, and informs the network (a) of the identities of those nodes that have been designated as Proxy Nodes by the CCo, and (b) of the identities of the discovered Hidden Nodes that will be served by each Proxy Node.

CCo_CONFIRM_MSG_SHORT

This message, illustrated in FIG. 8, is an abbreviated form of the CCo_CONFIRM_MSG message. It is used when only the identity of the CCo is broadcast to all nodes in the network at the end of the DISCOVER and ELECT processes.

BEACON_MSG

This is a message transmitted by the CCo in the OPERATE process (or state). Proxy nodes designated by the CCo may also re-transmit the BEACON. The BEACON message MUST carry the identity of the device transmitting the message. The CCo transmits the BEACON_MSG periodically in the OPERATE state.

The format of, and additional information in, the BEACON message may be entirely conventional in nature, and is not part of the present invention. It is assumed that during the LISTEN state, nodes can decipher a BEACON_MSG message when it is received. Receipt of a BEACON_MSG by a node other than the CCo informs the node that the network has been organized, and that a CCo has already been elected.

As is already apparent, various timers are employed in the implementation of the different processes and states of the invention. The text which now immediately follows generally defines these timers. The default values of these timers are known to all devices at initialization. The CCo may reset/change the values of these timers through the BEACON message.

1. T_LISTEN: This is the timer used by a node in the LISTEN state. T_LISTEN is the maximum duration of time that a node must spend in this state. T_LISTEN must be greater than the maximum time between network organization periods in the OPERATE state.

2. T_DISCOVER: This timer is used by nodes in the DISCOVER state. Every node must reset this timer to zero and restart the timer every time the node hears from another node for the first time, i.e., discovers a new node. Expiration of T_DISCOVER indicates that the node must exit the DISCOVER state and move to the ELECT state.

3. T_DISCOVER_REPEAT: This timer is used by nodes in the DISCOVER state. T_DISCOVER_REPEAT is the minimum amount of time that must elapse before a node transmits again in the DISCOVER state, having already transmitted at least once in the same state. Nodes attempt to transmit at the earliest feasible time after the T_DISCOVER REPEAT interval.

4. T_ELECT: This timer is used by nodes in the ELECT state. Every node must reset this timer to zero and restart the timer every time the node hears another node transmit an ELECT message for the first time. Expiration of this timer indicates that the node must exit the ELECT state and move to the CONFIRM state.

5. T_ELECT_REPEAT: This timer is used by nodes in the ELECT state. T_ELECT REPEAT is the minimum amount of time that must elapse before a node can transmit again during the ELECT state, having already transmitted at least once in the same state. Nodes attempt to transmit at the earliest feasible time after a T_ELECT REPEAT interval.

6. T_CONFIRM: This timer is used by nodes in the CONFIRM state. T_CONFIRM is the maximum duration of time that a node is allowed to spend in this state.

7. T_CONFIRM_REPEAT: This timer is used by nodes in the CONFIRM state. T_CONFIRM_REPEAT is the minimum amount of time that must elapse before a node can transmit again during the CONFIRM state, having already transmitted at least once in the same state. Nodes attempt to transmit at the earliest feasible time after a T_CONFIRM_REPEAT interval.

Following now in this disclosure text are further elaborations of the several states relating to practice of the invention.

LISTEN State

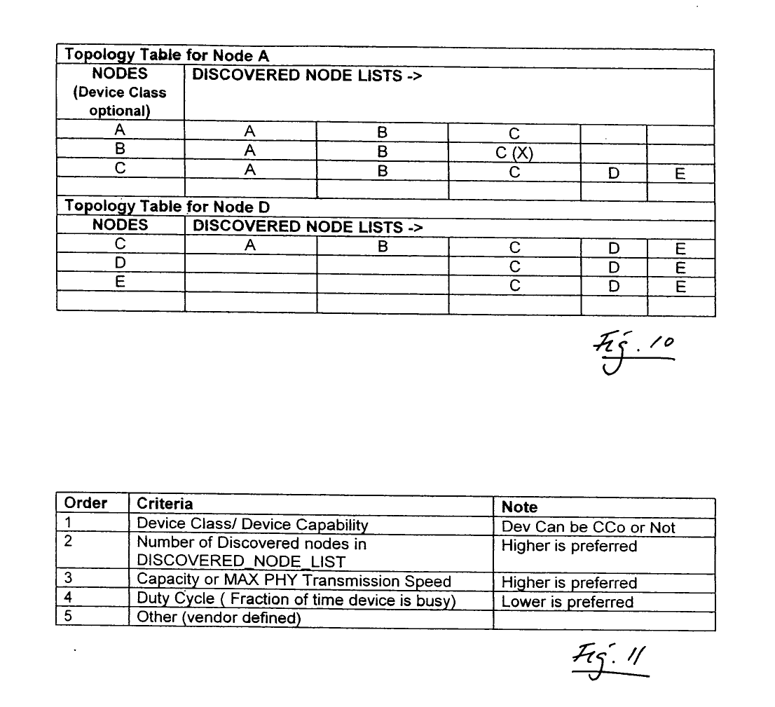

All nodes taking part in the practice of the present invention must begin in the LISTEN state. The different processes and decisions relevant to this state are pictured and outlined in FIG. 9. The block/schematic algorithmic content of this figure includes blocks 48-64 (even numbers only), inclusive. The respective questions and activities posed and engaged in by these blocks are clearly indicated in this drawing figure, as are the flows of control and processing illustrated by the interconnecting, single-arrow-headed lines.

Each node begins listening to the network channel (blocks 48, 50), and then “engages” the string of blocks extending between block 50 and block 64. Block 52 inquires whether a beacon is detected during the T_LISTEN period. If YES, indicating that a CCo has already been elected and that an organized network is in place, control passes to block 54 wherein the identity of the CCo is noted, and control then goes to block 56. If NO, processing control goes directly to block 56.

Blocks 56, 58, 62 sit in a concatenated string “downstream” from block 52, each posed to ask the respective different questions regarding whether a NODE_DISCOVER_MSG, a CCo_ELECT_MSG, or a CCo_CONFIRM_MSG message has been received. A NO answer reported from any of these blocks passes processing control successively downstream to the next block in the stream, ultimately to block 64. A YES answer from any one of blocks 56, 58, 62 immediately passes control to DISCOVER block 60 to initiate performance of the invention in its DISCOVER state.

Block 64, sitting as it does at the base of the string of blocks 56, 58, 62, asks the question whether the T_LISTEN period has expired. If YES, control goes to block 60. If NO, processing continues in a loop beginning through block 50, as shown.

Thus, and summarizing the performance just described with regard to FIG. 9:

1. A new node enters the LISTEN state by starting the T_LISTEN timer.

2. The node monitors the shared communication channel until it leaves the LISTEN state.

3. If a BEACON message is received by the node in this state, the node learns the identity of the CCo, and awaits the CCo's notification of a period of network organization wherein the process of the invention becomes further active. The CCo initiates a network organization period by broadcasting a NODE_DISCOVER_MSG (block 60).

4. If any of the following messages, NODE_DISCOVER_MSG, CCo_ELECT_MSG and CCo_CONFIRM_MSG, is received, the node immediately leaves the LISTEN state and moves to the DISCOVER state.

5. When the timer T_LISTEN expires, the node moves to the DISCOVER state.

DISCOVER State

Nodes in this state, entering via block 60 in FIG. 9, participate in a discovery process by advertising their presence periodically for an interval of time controlled by the T_DISCOVER timer. The nodes transmit the NODE_DISCOVER_MSG message in this state. The operations undertaken by a node in this state are described below.
1. Construct and Transmit the NODE_DISCOVER_MSG for the first time. Start its T_DISCOVER timer at the start of the transmission.
2. Repeat transmissions of the NODE_DISCOVER_MSG. Avoid collisions according to the medium access control protocol being used.
(a) If the only feasible time for the next transmission exceeds the T_DISCOVER limit, as measured from the start of the current transmission, no further transmissions are scheduled in the DISCOVER state.
(b) The time of the node's next transmission must be greater than T_DISCOVER_REPEAT as measured from the start of the current transmission from the node.
3. Listen to the Channel. When the node is not transmitting, the node listens to the communication channel.
(a) Whenever the node receives a NODE_DISCOVER_MSG message for the first time from a particular node, a list called DISCOVERED_NODES_LIST is updated with the ID of the new node. Every time a new node is discovered, the node resets the T_DISCOVER timer to zero, and restarts the timer. If a NODE_DISCOVER_MSG message is received from a node that has already been discovered, this message is ignored. This process results (a) in the nodes being synchronized, and (b) the end times of the T_DISCOVER time to be approximately the same for all nodes participating in the DISCOVER process.
(b) If the node receives a CCo_ELECT_MSG, or a CCo_CONFIRM_MSG message, the node ignores these messages. However, the node may update its DISCOVERED_NODES_LIST with the identity (MAC address) of the source when it receives one of these messages.
4. Expiry of T_DISCOVER and move to ELECT state: When T_DISCOVER expires, the node exits the DISCOVER state and begins operating in the ELECT state.
   ELECT State

Nodes participate in an election process after the DISCOVER state to choose an appropriate node to play the role of CCo. This is done by having the nodes exchange their DISCOVERED_NODES_LIST. Each node then compiles for itself a TOPOLOGY_TABLE using this list. This table indicates which node has access to the largest number of nodes in the network. It also indicates hidden nodes and nodes that may work well as proxy nodes. A set of rules applied to the TOPOLOGY_TABLE enable each node to decide for itself which node is ideal to serve in the role of a CCo.

Nodes may choose to use any appropriate protocol for medium access control, and employing this protocol transmit the CCo_ELECT_MSG message when they are in the ELECT state. The processes involved in the ELECT state are as follows:

1. Construct and transmit CCo_ELECT_MSG message for the first time. The node assembles the message to be transmitted in the ELECT state in the format discussed above with respect to the structure of the CCo_ELECT_MSG message. The node includes its DISCOVERED_NODE_LIST in the CCo_ELECT_MSG. It starts the T_ELECT timer at the start of the transmission.

2. Repeat transmissions of the CCo_ELECT_MSG. Avoid collisions according to the medium access control protocol being used.
(a) If the only feasible time for the next transmission exceeds the T_ELECT limit, measured from the start of the current transmission, no further transmissions are scheduled in the ELECT state.
(b) The time of the node's next transmission must be greater than T_ELECT_REPEAT measured from the start of the current transmission from the node.

3. Listen to the Channel. When the node is not transmitting, the node listens to the communication channel. The response from the node is based on the kind of message received during this monitoring.
(a) Receiving the NODE_DISCOVER_MSG:
(1) Whenever the node receives a NODE_DISCOVER_MSG message for the first time from a particular node, a list called DISCOVERED_NODES_LIST is updated with the ID of the new node. Every time a new node is discovered or when a node leaves the ELECT state for the DISCOVER state, the node leaves its current state (ELECT) and enters the DISCOVER STATE. It begins operating in the DISCOVER State as discussed above. The node resets the T_DISCOVER timer to 0 and restarts the timer.
(2) If a NODE_DISCOVER_MSG message is received from a node that has already been discovered but was in the ELECT state, the node leaves its current state (ELECT) state and moves to the DISCOVER state. This ensures that all nodes in ELECT state move to the DISCOVER state when a new node or a hidden node causes one such node to revert from ELECT to DISCOVER.
(3) However, if the node receives a NODE_DISCOVER_MSG from a node that has not yet left the DISCOVER state but has been discovered, then the node can continue with the transmissions of the CCo_ELECT_MSG message. This allows nodes to transition from DISCOVER to ELECT states.
(b) If the node receives a CCo_ELECT_MSG, it updates its TOPOLOGY_TABLE with the DISCOVERED_NODE_LIST from the received message. If the node receives a CCo_ELECT_MSG message from a node for the first time, the node resets its own T_ELECT timer to zero and restarts the timer. The node then continues scheduling and transmitting its own CC_ELECT_MSG messages. This process results in the nodes being synchronized in the ELECT state and the end times of the T_ELECT timers to be approximately the same for all nodes participating in the ELECT process.
(c) If the node receives a CCo_CONFIRM_MSG, the message is ignored.

4. Expiry of T_ELECT and move to CONFIRM State. When T_ELECT expires, the node exits the ELECT state and moves to the CONFIRM state. The node must renew its T_ELECT timer and continue in the ELECT state if it has not received at least one CCo_ELECT_MSG from every node on its DISCOVERED_NODE_LIST, i.e., all discovered nodes must be in the ELECT state together before any one of them can move to the CONFIRM state. This ensures that every node receives the DISCOVERED_NODE_LIST of every node on its own list.

The resulting discovered node list is thus a data structure that contains the MAC addresses of all of the nodes discovered as a part of the discovery process. The list may optionally contain the Device Class/Type of each of the discovered nodes on the list.

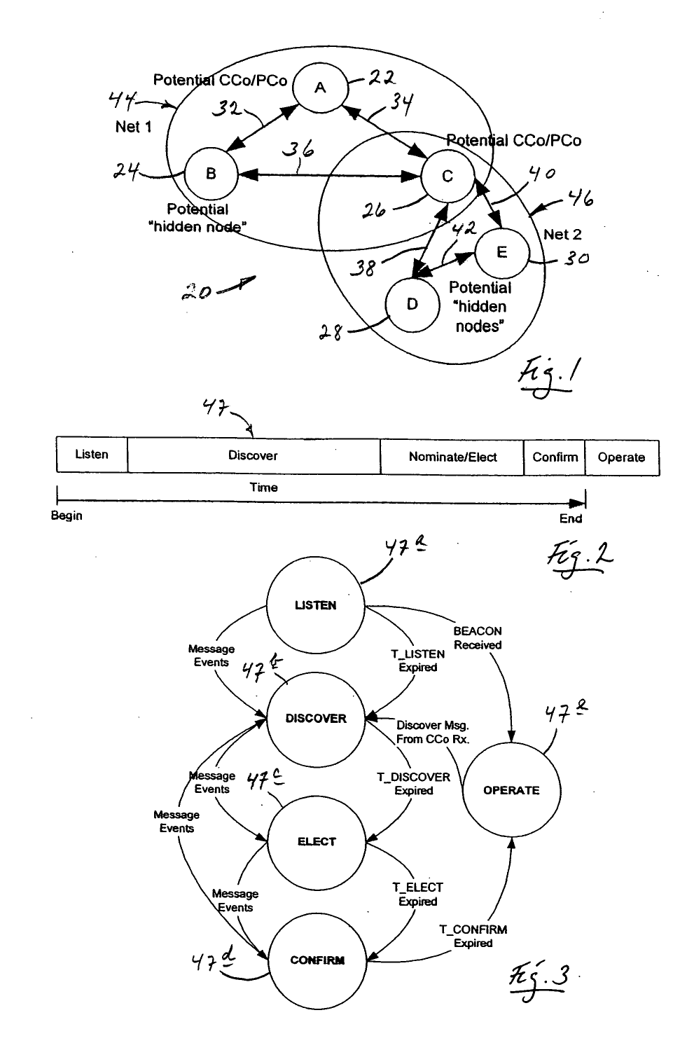

Turning attention now to the topology table structure constructed by each node, the tables for nodes A(22) and D(28), pictured in FIG. 1, are shown in FIG. 10. As can be seen in FIG. 10, the topology table of node A is a tabulation of the DISCOVERED_NODE_LISTS for all the nodes that have been directly discovered by node A. It does not include the DISCOVERED_NODE_LISTs from nodes that have not been heard by node A. Thus, the topology table for node A consists of its own discovered nodes list (A, B, C) in the first column. The rows correspond to the discovered node lists received from each of these nodes. For example, DISCOVERED_NODE_LIST of node A is (A,B,C), but that of node C is (A,B,C,D,E).

Note that it may be possible that node B can hear C, but that node C might not be able to hear node B. This implies that the link between B and C is not operational in both directions (non-bi-directional) and hence is not a valid link. This example is illustrated by (X) in the Discovered Node List from B in node A's topology table. B does, however, show up in C's list. The TOPOLOGY_TABLE may also keep track of the Device Class of each node that has been discovered if such a scheme is implemented by the system. Additional information such as the quality/capacity of each link may also be maintained in each entry for the discovered node list.

CONFIRM State

Once the election process has been completed, each node has a TOPOLOGY_TABLE that summarizes the identities of nodes that have been discovered, and the DISCOVERED_NODE_LISTS for all the nodes that have been discovered. The steps taken by each node in this state are as follows:

(1) Analyze the TOPOLOGY_TABLE assembled during the ELECT state. Identify the node that is best suited to be the Central Coordinator (CCo). This analysis and the decision is made in a completely de-centralized fashion with each node making the decision independent of other nodes.

2. The node that is not selected as the CCo, remains silent during the CONFIRMATION state and monitors the channel for the CCo_CONFIRM_MSG message transmitted by the node chosen as the CCo. Upon receipt of a CCo_CONFIRM_MSG message, the node learns the organization of the network in terms of the identities of the CCo, and of any proxy nodes and hidden nodes. The node moves into the OPERATE state when it stops receiving CCo_CONFIRM_MSG messages and subsequently receives its first BEACON message from the CCo in the OPERATE state. The node may be chosen to be a PCo in the OPERATE state.

3. A node that decides that it is the CCo as a result (1) of TOPOLOGY_TABLE analysis, and (2) based on rules outlined below relating to the selection of the CCo, transmits a CCo_CONFIRM_MSG message after every T_CONFIRM_REPEAT interval for a total duration determined by the T_CONFIRM timer. The CCo_CONFIRM_MSG identifies (a) the nodes within the core network, (b) any proxy controllers (or PCos), and (c) the identities of the hidden nodes being controlled through the PCos.

4. When T_CONFIRM expires, the CCo node moves to the OPERATE state and begins transmitting BEACON messages.

5. If at any time during the CONFIRM state a NODE_DISCOVER_MSG message is received from a node that has not been heard from (or discovered) before, or from a node that was in the ELECT state but reverted to the DISCOVER state, all nodes in the CONFIRM state revert to the DISCOVER state, and the process starts over again. This may selectively be treated as an optional step, if one so desires, and a modified approach might be chosen which prohibits any new nodes from interfering with the confirmation of the CCo.

6. If a node in the CONFIRM state receives a message from a node that has just entered the ELECT state, i.e., receives its first CCo_ELECT_MSG after being in the DISCOVER state most recently, then the node leaves the CONFIRM state and moves back to the ELECT state.

7. If a node that broadcasts the CCo_CONFIRM_MSG follows that up with the broadcast of a NODE_DISCOVER_MSG, or of a CCo-ELECT-MSG, then all nodes in the CONFIRM state must leave that state and revert to the DISCOVER or ELECT states, respectively.

8. When more than one node independently determines that it is the most suitable candidate to be the CCo, and if the nodes are using some form of a contention access protocol, every potential CCo would attempt to transmit a CCo_CONFIRM_MSG. In order to prevent this, and in accordance with practice of the present invention, every node that is a CCo candidate must remain silent if it hears a CCo_CONFIRM_MSG from another node, and it must accept the source of that message as the actual CCo. A candidate node may only transmit a CCo_CONFIRM_MSG and continue to retransmit it for the T_CONFIRM period, if it has not heard any other node transmit the same type of message.

### Topology Table Analysis

Considering now the process of topology table analysis, let DA represent the DISCOVERED_NODE_LIST for node A, i.e. the set consisting of the identities of all nodes that node A has heard.

The Topology Table for Node A is then defined as a tabulation of the DISCOVERED_NODE_LISTS for all the nodes in DA i.e.,
T_{A}={Dᵢ}∀iεD_{A}
Non-Bidirectional Link Detection

Considering two nodes, i and j. If a node i has been discovered by node j, i.e., if the identity of i is an entry in the DISCOVERED_NODE_LIST of node j, but node j has not been discovered by node i, i.e., there is no entry for node j in the DISCOVERED_NODE_LIST of i, then the link between i and j is said to be non-bidirectional.

For any two nodes, i and k, if i, kεDᵢ∩Dₖ then i and k have a bidirectional link, i<=>k

### Organization of Network

A network can be defined as the largest collection of nodes from a group of nodes that participate in the topology discovery and network organization processes, where every node in the collection can hear every other node and be heard by every node in the collection. This implies that all nodes in a network have bi-directional links to each other. Define:
N≡{i}, where i represents node IDs and ∀i, jεN, i<=>j and
   |N|≧{Any Collection of nodes {j} where ∀i, jεN, i<=>j}

The second condition present in the mathematical expression appearing immediately above is optional. One may thus define a network simply as any collection of nodes wherein the nodes are connected to each other bi-directionally. The node can determine the network N based on the above definition by examining the TOPOLOGY_TABLE and determining the set of nodes which have the properties defined in this expression.

### Selection of Central Coordinator CCo

Once a network has been organized, and the set N determined from the TOPOLOGY_TABLE, each node has to determine the node in N that is best suited to serve in the role of CCo. The criteria for choosing the CCo may be different. Any one or a combination of these criteria may be used in the selection of CCo. The criteria, such as those set forth below, must be agreed to and known by all the nodes participating in the process.

1. Maximum Coverage: The node in the network N which supports bidirectional links with the maximum number of nodes provides the best coverage and may be deemed suitable to be a CCo. Then, by definition,

$$CCo ≡ Arg {max}_{i} \vert {D}_{i} \vert ∀ i ∈ N ,$$

and for every k E Dᵢ, i, kεDᵢ∩Dₖ

2. Maximum Capacity: As a part of the ELECT state, nodes may exchange information on the quality of the reception for each node discovered in the DISCOVER state. This would require a common agreement among all nodes on the parameters defining the transmission of the messages in these states, such as transmit power levels, modulation, coding etc. This quality indicator would convey to the transmitting node the quality of the link or communication channel between the two nodes, and would help the transmitter determine the best throughput (bits/sec) that may be possible on a given link or the link capacity. In the case of channels that may be time-varying (on rapid time scales), the quality indicator might be less relevant in determining potential capacity of the link.

Assuming that the above method, or some alternate method not specified here, may be used to determine link capacity, the node which can support the best overall throughput, defined either as the maximum of the minimum throughputs on all link to/from that node, or as the sum of throughputs of all links to/from the node, may be chosen as the CCo. The node is selected from the set N.

3. Device Class: Based on the class of each of the nodes in N, the node in N with the best capabilities or the highest class may be chosen as the CCo.

4. Lowest Duty Cycle: In some networks, devices can only transmit or receive any given time. In such systems, it is useful to select as the CCo a node that is not busy transmitting data for its own purposes (such as a video server transmitting SDTV/HDTV). This allows the node to dedicate most of its processing resources to network control functions and more efficiently use available channel bandwidth. As a part of the DISCOVER and ELECT processes, devices may exchange parameters to indicate how busy a node is likely to be. The NODE_DISCOVER_MSG as well as the CCo_ELECT_MSG can have an additional parameter called ACTIVITY INDICATOR which is a percentage of time the device is likely to spend transmitting/receiving data for purposes other than network control. The node with the lowest ACTIVITY_INDICATOR may be chosen as the CCo in conjunction with other suitable criteria such as the coverage.

5. Combination of above factors: A combination of the above criteria may be used to determine the CCo. For example, a higher class device might get precedence over a lower class device even though the number of nodes reached by the lower class device is slightly higher. Or, a device that is not transmitting/receiving any data may have precedence over a device that is of a higher class, but one that is likely to be busy transmitting its own data.

6. Tie breaker: If there is a tie among nodes in N for choice of CCo, a candidate node uses a suitable contention access protocol to determine which node becomes the CCo. Every candidate node must listen to the channel for a random time interval before transmitting its CCo_CONFIRM_MSG. The node that first transmits is by default the CCo. All candidate nodes remain silent once they receive a CCo_CONFIRM_MSG.

7. Order for selection of CCo: An alternative to prevent use of the tie breaker option can be expressed as follows. If there is a tie among nodes in N for choice of CCos, the CCo may choose one of the candidate nodes at random to be the new CCo. This order of selection consideration is illustrated in FIG. 11.

### Hidden Nodes

Once the TOPOLOGY_TABLE has been analyzed to define the network N, all those nodes in the topology table of the CCo that do not belong to N are declared as “hidden nodes” i.e.

If node k∉N then “k is a hidden node”.

### Proxy CCo

The node that has been chosen to be the CCo examines its TOPOLOGY_TABLE to determine if there are other nodes that can best communicate with the hidden nodes also identified by examination of the table. If there exists a node, say j, that belongs to the network N, and has a bidirectional link to the hidden node, say k, that does not belong to N, then that node may be designated a Proxy Coordinator or PCo i.e., jεN, k∉N, j<=>k, then j is a potential PCo.

In order to determine the PCos such that all possible hidden nodes are covered by a single PCo and not multiple PCos, the following algorithm is implemented.
1. Let S_{PCo} represent the set of Proxy Coordinator nodes.
2. For each node kεDᵢ for some DᵢεT_{CCo}, and k∉N, if there exists a node jεN, and jεS_{PCo}, and j<=>k, then j is the PCo for node k.
3. For each node kεDᵢ for some DᵢεT_{CCo}, and k∉N, if there exists a node jεN, and j∉S_{PCo}, and j<=>k, then j is designated the PCo for node k and added to the set of PCos, S_{PCo}.
4. For each node kεDᵢ for some DᵢεT_{CCo}, and k∉N, if there DOES NOT exist a node jεN, and j<=>k, then the hidden node k cannot be reached by any node in the network N and therefore has no PCo.

### OPERATE State

In this state, there exists a CCo and a network that has already been organized. However, the topology of the network changes whenever a new node joins the network, and whenever a node (including the CCo) leaves the network. The CCo, during the OPERATE state must allow for these events. There is a fundamental difference between how the network functions in the OPERATE state when compared to other states in the practice of the invention. In the OPERATE state, the network is centrally controlled, and medium access is scheduled by the CCo within time frames. The protocol associated with the present invention by definition is a distributed protocol. In networks where the OPERATE state still involves operation without centralized access control, practice of this invention also has a useful application. The steps required to activate steps within the OPERATE state are as follows:

1. The CCo is required to schedule a network organization interval periodically. The time period is a system parameter that must be known to all devices a priori. The T_LISTEN timer must be set to a value greater than the maximum time between such organization intervals. This ensures that a new node will have an opportunity to participate in the discovery and organization process via DNOA.

2. The CCo starts DNOA by transmitting a NODE_DISCOVER_MSG. All nodes in the network then enter the DISCOVER state of the DNOA.

3. In the CONFIRM state, the node winning the CCo election as per the analysis described earlier takes over the role of the new CCo and initiates a new frame structure. IF no new nodes are discovered during the organization interval, or the link characteristics between nodes have not changed substantially (i.e., links have not disappeared), the existing CCo will continue in its role, and will reconfirm itself during the CONFIRM state of DNOA as the CCo. BEACON transmission, scheduled access, and all other normal network operations will resume at the end of the organization period.

Thus, the invention offers a unique distributed network organizational method (algorithm) for organizing nodes in a network which, at least initially, contains no designated central coordinator node. Application of the invention, which involves the discovery and topology-categorizing of all nodes, including hidden and assigned proxy nodes which can act as communication conduits for hidden nodes, has utility not only during the initial formation of a network, but also later on when certain events, such as the entry of a new node, or the recovery from a network interruption occur. Assignment of a central coordinator node takes place through a node-election process based upon information developed during the comprehensive pre-establishment of a topology table for the entire prospective network. In an established network, bi-directional communication is enabled between all nodes, including hidden nodes whose ability so to communicate is established by designated proxy nodes.

Accordingly, while a preferred manner of implementing the invention is specifically described and illustrated herein, variations and modifications are certainly understood to be possible which will lie within the scope and spirit of the invention.

1. A distributed network organization method for self-organizing a group of nodes into a communication network where the nodes are all operatively connected to a shared communication medium, said method comprising
placing the nodes, for up to a selected time interval, in a condition of listening over the medium for the occurrence of a message indicating the presence of a central coordinator (CCo) node, and
at a point in time following the conclusion of that interval, if there has been no such message occurrence, and under the collective action the node group, creating a network topology understanding which results in the activity of selection, from the group, of a CCo, and the production of a network organization utilizing such topology understanding.

2. The method of claim 1, wherein said organization production includes the recognition of hidden nodes, and the naming of intermediary proxy nodes which enable the mentioned effective bidirectional communication between each hidden node and other nodes.

3. The method of claim 1, wherein said creating of a network topology includes the per-node, individual creation of a discovered nodes list that describes direct internodal communication capabilities, and such selection activity is performed, at least partially, on the basis of the contents of such lists.

4. A distributed network method for self-organizing a group of nodes into a communication network where the nodes are all operatively connected to a shared communication medium and there is no central coordinator node, said method comprising
engaging in the process of determining direct internodal communication capabilities, and
as a consequence of said engaging, electing a best-suited central coordinator node for a network.

5. The method of claim 4 which further comprises, following electing of a central coordinator node, identifying hidden nodes, and choosing intermediary proxy nodes to enable all-node internodal communication capability through such proxy nodes with the hidden nodes.

6. A method for organizing, from a group of nodes, a communication network based upon the assumption that the organized network will, initially, lack a central coordinator, said method comprising
determining which nodes in the group are optimally capable of becoming organized into a desired network,
enabling the so-determined nodes effectively each to learn (a) the identities of other nodes in the group which have also been so determined, and (b), with respect to all of these so-determined nodes, the respective qualities of communication links that directly exist between pairs of the nodes, and
on the basis of such learning, creating a discovered topology table which provides a guiding tool for the current definition and formation of the desired network.

7. A method for organizing, from a group of nodes, a communication network based upon the assumption that the organized network will, initially, lack a central coordinator, and in a setting wherein each node in the group has topology knowledge regarding (a) the identities of all other nodes in the group, and (b) the respective qualities of communication links that directly exist between different ones of these nodes, said method comprising
performing an analysis of such topology knowledge to identify the most appropriate candidate node to perform, in at least the immediate future, the role of a central coordinator node, and
following said performing, collectively engaging plural nodes in the group in the selection of that candidate node to be the then-designated central coordinator node.

8. The method of claim 7, wherein the activity involving selection includes a Maximum Coverage criterion which is applied to determine the node in the network which supports bi-directional links with the maximum number of nodes.

9. The method of claim 7, wherein the activity involving selection includes a Maximum Capacity criterion which is a applied to determine the node in the network which exhibits the most desirable throughput characteristics.

10. The method of claim 7, wherein the activity involving selection includes a Device Class criterion which is applied to determine which node in the network possesses the highest class among the nodes.

11. The method of claim 7, wherein the activity involving selection includes a Lowest Duty Cycle criterion which is applied to determine the node in the network which is characterized with having the highest percentage of time devoteable to attending to network control functions.

12. The method of claim 7, wherein the activity involving selection includes a combination of plural criteria selected from the list including (a) Maximum Coverage, (b) Maximum Capacity, (c) Device Class, and (d) Lowest Duty Cycle.

13. The method of claim 7, wherein the activity involving selection includes a Tie Breaker criterion which is applied when applications of criteria to determine the best node to be the CCo produce a tie among nodes.

14. The method of claim 7, where the activity involving selection includes, for use in lieu of use a Tie Breaker criterion as described in claim 13, an Order for Selection criterion as illustrated in FIG. 11 herein.

15. A distributed network method for self-organizing a group of nodes into a communication network, where the nodes are all operatively connected to a shared communication medium, certain nodes may be hidden nodes, and there is an initial assumption that there is no central coordinator node, said method comprising
engaging in a discovery process to identify the qualities of direct and indirect internodal communication capabilities, and
as a consequence of said engaging, establishing, as desired, at least one proxy node to facilitate bi-directional communication with any hidden nodes.

16. The method of claim 15, wherein the following algorithm is employed in the establishment of a proxy node:
1. Let S_{PCo} represent the set of Proxy Coordinator nodes.
2. For each node kεDᵢ for some DᵢεT_{CCo}, and k∉N, if there exists a node jεN, and jεS_{PCo}, and j<=>k, thenj is the PCo for node k.
3. For each node kεDᵢ for some DᵢεT_{CCo} and k∉N, if there exists a node jεN, and jεS_{PCo}, and j<=>k, then j is designated the PCo for node k and added to the set of PCos, S_{PCo}.
4. For each node kεDᵢ for some DᵢεT_{CCo}, and k∉N, if there DOES NOT exist a node jεN, and j<=>k, then the hidden node k cannot be reached by any node in the network N and therefore has no PCo.
